(19) United States
(12) Patent Application Publication
(10) Pub. No.: US 2010/0114155 A1
(43) Pub. Date: May 6, 2010

(54) APPLIANCES FOR TREATING HOOFED ANIMALS

(76) Inventor: Itzhak Siani, D"n hof Ashkelon (IL)

Correspondence Address: YORAM TSIVION, P.O. BOX 1307, PARDES HANNA, 37111, IL

(21) Appl. No.: 12/597,767

(22) PCT Filed: Apr. 27, 2008
(86) PCT No.: PCT/IL08/00544

§ 371 Date: Oct. 27, 2009

Related U.S. Application Data
(60) Provisional application No. 60/914,321, filed on Apr. 27, 2007.
(60) Provisional application No. 60/956,034, filed on Aug. 15, 2007.

(51) Int. Cl. A61D 9/00; A01L 9/00; A01L 15/00

(52) U.S. Cl. 606/212; 168/24

(57) ABSTRACT

A support for treating a cloven hoof of an animal including a sole providing elevation, to one toe of a hoof of the animal. A toe securing structure (TSS) is joined to the sole. A foot securing means is connected in one end to the sole, while the other ends of the securing means are fastened together such that the sole is tightly secured to the animal cloven hoof. In another aspect of the present invention, in order to treat hoof disorders such as fungal infection, which typically plague the area between the toes of a cloven hoofed animal, a medical composition is delivered from a bandage. After use, the bandage can be discarded without being touched. The bandage is preferably made of degradable and environment-friendly materials.

### CROSS-REFERENCE TO RELATED APPLICATIONS

The present application claims priority from U.S. provisional patent application Ser. No. 60/956,034, filed Aug. 15, 2007, entitled “Appliances for treating hooved animals”. The present application claims priority also from U.S. provisional patent application Ser. No. 60/914,321, filed Apr. 27, 2007, entitled “Appliances for treating hoofed animals”.

### FIELD OF THE INVENTION

The present invention relates to a method and apparatus for treating hoof infections or other problems associated with hooves. More specifically, the present invention relates to appliances applied to aid the animal in recuperation from hoof damage.

### BACKGROUND OF THE INVENTION

In typical modern animal husbandry practices, cows are left to stand on their feet ten to twelve hours per day. Lameness, abscess, dermatitis and other hoof diseases pose a regular problem especially as regards confined dairy cows, representing one of the major reasons cows are culled from the herd. When lameness is not controlled, dairy producers suffer substantial economic loss. Lameness has been shown to be associated with delayed estrus, poor breeding performance, shortened lactation, low yield of milk fat and sudden drop in body weight, all of which have a negative effect on profitability of the herd. It is therefore desirable to provide means to remedy or provide relief to such an ailment for livestock such as cow or buffalo. U.S. Pat. No. 4,444,269 the contents of which are incorporated herewith by reference discloses a hoof cover including a base, toe cap overlying a front portion of a base, first fastener support means extending to the rear of the base and second fastener support mean extending from the rear of the toe cap. Such cover provides a protection in situations wherein a bandage or treatment has been applied to the animal's hoof.

### BRIEF DESCRIPTION OF THE DRAWINGS

FIG. 1A is an isometric view of a hoof support in accordance with a preferred embodiment of the present invention;

FIG. 1B is an isometric view of a hoof support including a strap fastened by a Velcro fastening means;

FIG. 1C is an isometric rear view of a hoof support in accordance with a preferred embodiment of the present invention;

FIG. 2 is an isometric view of a hoof support including an elastic sock in accordance with a preferred embodiment of the present invention;

FIG. 3 is an isometric view of a hoof support including a double-layered elastic sleeve;

FIG. 4 is an isometric view of a hoof bandage in accordance with a preferred embodiment of the present invention;

FIG. 5 is an isometric view of a hoof bandage in accordance with a preferred embodiment of the present invention with internal packets described with dashed lines;

FIG. 6 is an isometric front view of a hoof sandal in accordance with some embodiment of the present invention;

FIG. 7 is an isometric rear view of a hoof sandal in accordance with some embodiment of the present invention;

FIG. 8 is an isometric front view of a hoof sandal in accordance with some embodiment of the present invention with a leg securing member passing between the cloven hoof toes;

FIG. 9 is an isometric rear view of a hoof sandal as in FIG. 8, with animal foot not shown.

### DETAILED DESCRIPTION OF THE PRESENT INVENTION

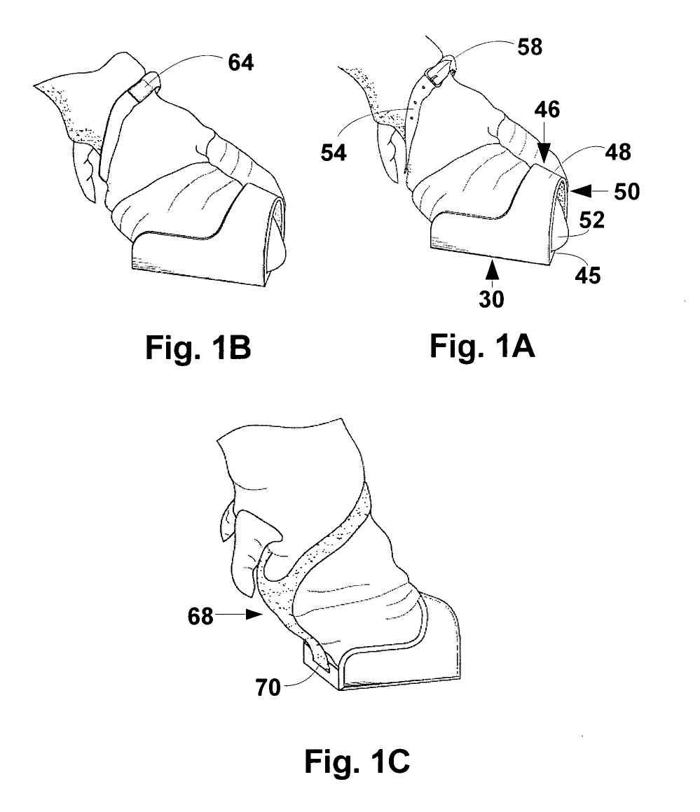

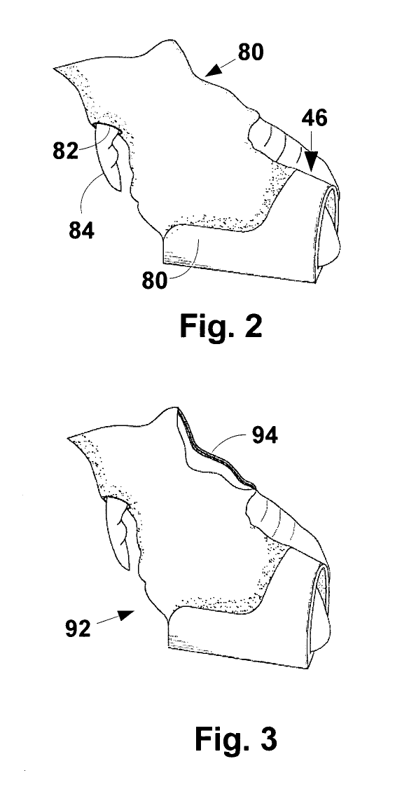

An isometric schematic view of a hoof support in accordance with the preferred embodiment of the present invention is described in FIG. 1A to which reference is now made. A hoof of a cow is shown wearing a hoof support over the right toe of the hoof. The hoof support includes sole 30 that provides elevation to the right toe of the cloven hoof. The sole is made of a rigid or elastic material. The sole is thick enough that the animal will not step on the damaged left toe of the hoof. The hoof support further includes toe securing to structure (TSS) 46. The TSS may be constructed in several predefined sizes to account for difference in size of the individual animal hoof. Generally, the TSS may be defined as a modified tube. For example, two surfaces, either planar or curved are joined to the opposing flanks of sole 30 and at the front end of the foot support the two surfaces joined to form annular structure 48. Through annular aperture 50 surrounds toe 52 a portion of toe which is shown protruding the degree of protrusion depends on various dimensional aspects of the hoof, and hoof support. The hoof support further includes leg securing member or members such as straps 54 connected in one end to the sole. The straps are made from strong material such as rubber, plastic or leather. In the presently described embodiment, the other ends of the straps are fastened together such that the sole is tightly secured to the animal cloven hoof. This end of the straps may be connected for example by sewing, tying, buckling 58 or as can be seen in FIG. 1B to which reference is now made, by Velcro fastening means 64. In another embodiment of the present invention described in FIG. 1C, strap 68 is connected on one end to the sole at site 70, bifurcating further upwards, such that the straps encircle the hoof of the animal and further are joined together for example by sewing, tying, buckling or by Velcro fastening means. An isometric view of a hoof support including an elastic sock in accordance with a preferred embodiment of the present invention is described in FIG. 2 to which reference is now made. Elastic sleeve 80 is attached for example by sewing or gluing to the upper part of the hoof support. The sleeve is formed such that it is fastened to the leg of the animal. In addition, the sleeve has at least one aperture 82 in order that dewclaw of the animal 84 can extrude from the sleeve through the aperture. An isometric view of a hoof support including a double-layered elastic sleeve is shown in FIG. 3 to which reference is now made. In this example cloven hoof support 92 includes elastic double-layered sleeve 94 and within, an inflatable pillow. The pillow can inflate by a pump, not shown in FIG. 3. It should be noted that the cloven hoof support implemented in accordance with the present invention can support at least one toe of at least one foot of a cloven hoofed animal.

In another aspect of the present invention, in order to treat hoof disorders such as fungal infection, which typically plague the area between the toes of a cloven hoofed animal, a medical composition is delivered from a bandage. After use, the bandage can be discarded without touching. The bandage is made of degradable and environment-friendly materials. Some examples of embodiments of this aspect are described herein below.

Example 1: releasing the bandage from the animal foot with a stream of hot or cold water.

Example 2: the bandage is adhered or bonded to the animal foot with a Removable adhesive disposed in the interior side of the bandage and can be removed after a while without leaving residue on the adherend. The adhesive may be natural adhesives made of an inorganic mineral sources, or biological sources such as vegetable matter, natural resin, animal skin and bioadhesives.

Example 3: the bandage is made of composite material being crumbled with water or being crumbled after a period of time and without water.

Example 4: releasing the bandage from the animal foot when the foot touches cow waste.

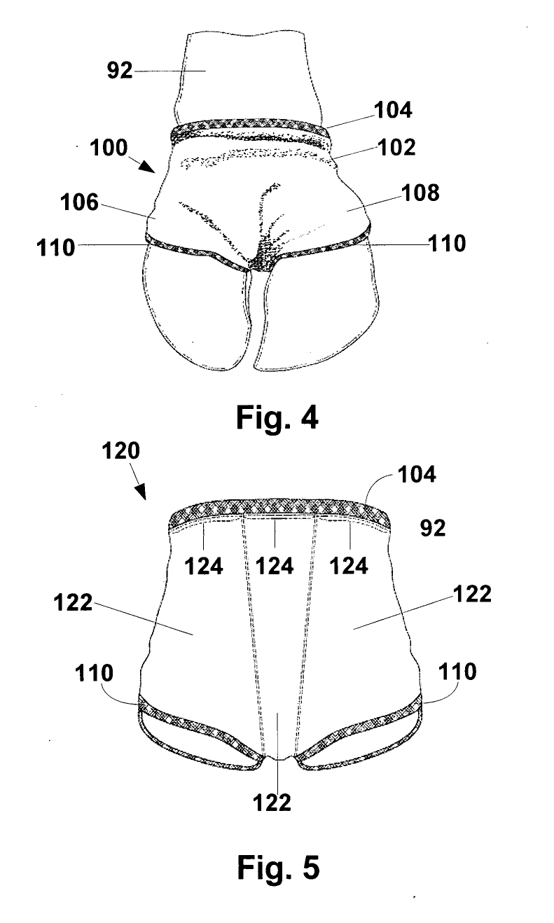

An isometric view of an exemplary hoof bandage in accordance with an embodiment of the present invention is described in FIG. 4 to which reference is now made. Bandage 100 includes leg encircling portion 102 that is bound along its top rim using an elastic leg-band 104 typically attached to the bandage 100. At the area of bifurcation of toes, the leg encircling portion is divided into left toe member 106 and right toe member 108. Attached at the bottom rim of each toe member, is elastic toe-band 110. In accordance with one embodiment of the present invention the leg encircling portion is impregnated with a therapeutic ointment. After bandaging the damaged hoof, the impregnated medical composition in the bandage is delivered to the hoof parts which the bandage covers or to adjacent areas. In accordance with another aspect of the present invention a medical composition is placed on the damaged hoof of the animal and non-impregnated bandage is applied on the damaged foot over the ointment. In another aspect of the present invention a medical preparation is delivered from a bandage pocket. An isometric view of an exemplary hoof bandage delivering medical preparation from a bandage pocket is described in FIG. 5 to which reference is now made. Bandage 120 is furnished with three pockets 122 which can be attached to the inner side of the bandage for example by gluing or sewing. Medical preparations are then applied inside the pockets through pocket apertures 124 respectively. The internal area of the to pocket facing the leg of the animal can be made from a porous fabric such that the medical preparation is delivered to the damaged leg easily.

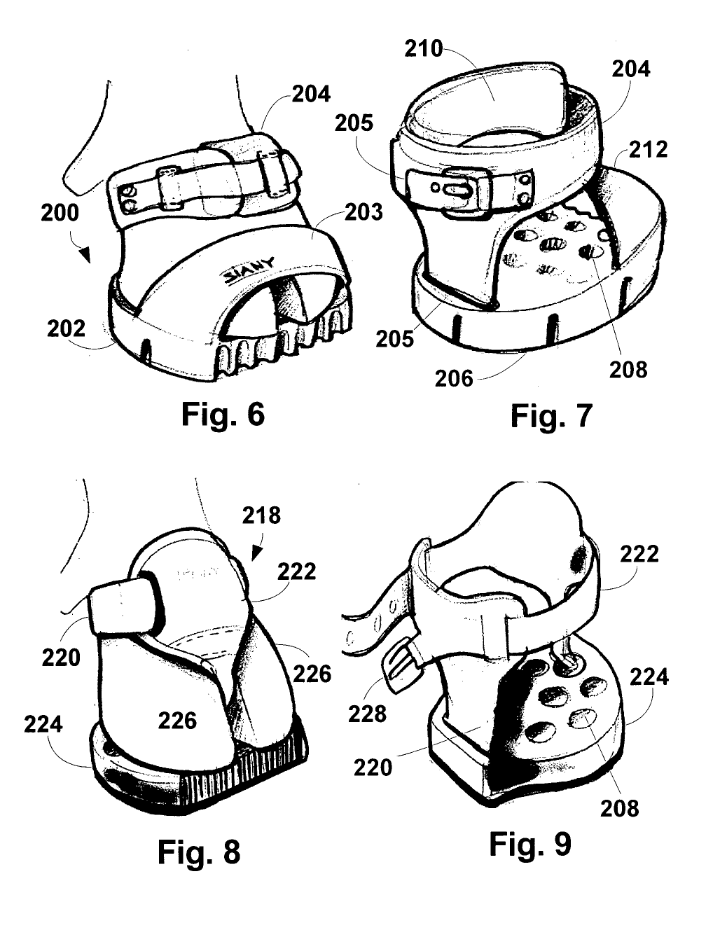

In another aspect of the present invention a sandal is slipped over a cloven hoof of an animal, particularly a cow. The sandal in accordance with the present invention prevents continuing damage to the animal cloven hooves. An isometric front view of a hoof sandal in accordance with some embodiment of the present invention is described in FIG. 6 to which reference is now made. Sandal 200 includes sole portion 202 which is made of a rigid or elastic material such as wood, leather, rubber, plastic, jute, polyurethane, or any combination thereof. The hoof sandal further includes toes securing portion (TSP) 203. The TSP may be prepared in several predefined sizes to account for difference in size of the individual animal hoof. For example, two surfaces, either planar or curved are joined to the opposing flanks of sole 202 and at the front end of the foot support the two surfaces joined to form an annular structure. Through annular aperture surrounds toes a portion of the toes which are shown protruding the degree of protrusion depends on various dimensional aspects of the hoof, and hoof support. The sandal further includes one or more leg securing members such as strap 204 connected in one end to sole 202. The straps are made from strong material such as rubber, plastic or leather. In the presently described embodiment, the other ends of the straps are fastened together such that the sole is tightly secured to the animal cloven hoof. This end of the straps may be connected for example by sewing, tying, Velcro fastening means or as can be seen in FIG. 7 to which reference is now made, by buckling 205. In one embodiment of the present invention sole portion 206 is perforated such as hole 208. In other aspect of the present invention the inner side of strap 210 is padded with a soft martial such as synthetic furring. In another embodiment of the present invention the TSP assumes the shape of toes pocket 212. An isometric front view of a hoof sandal in accordance with another embodiment of the present invention is described in FIG. 8. Sandal 218 includes sandal leg securing member or members such as strap 220 and 222 which are connected in one end to sole 224. Strap 222 passes between the cloven hoof toes 226 and the strap is wider as the strap is away from the sole. In the presently described embodiment, the other ends of the straps are fastened together such that the sole is tightly secured to the animal cloven hoof. As can be seen in FIG. 9 to which reference is now made straps 220 and 222 are fastened together by buckling 228.

1. A support for treating a cloven hoof of an animal comprising:
a sole;
a toe securing structure joined to said sole: and
a foot securing means connected in one end to said sole and wherein the other ends of said securing means are fastened together such that said sole is tightly secured to said animal cloven hoof,
wherein the sole comprises a sole portion to provide elevation to a toe of the hoof of the animal relative to the other toe(s).

2. The support as in claim 1, further comprising an elastic sleeve attached to an upper section of the support.

3. The support as in claim 1, wherein said sole is perforated.

4. A bandage for treating hoof disorders, comprising:
a leg encircling portion bound along a top rim of the bandage using an attached elastic leg-band, said leg encircling portion being divided into a left toe member and a right toe member, wherein at the bottom rim of each of said toe members there are respectively attached two elastic toe-bands.

5. The bandage as in claim 4, further comprising at least one pocket attached to the inner side of said bandage.

6. The bandage as in claim 5, wherein the internal area of said pocket facing the leg of the animal is made from a porous fabric.
